(19) United States
(12) Patent Application Publication
(10) Pub. No.: US 2020/0369927 A1
(43) Pub. Date: Nov. 26, 2020

(54) PRINTED AND COATED RELEASE FOIL

(71) Applicant: Loparex Germany GmbH & Co. KG, Forchheim (DE)

(72) Inventors: Sahin SAYGILI, Forchheim (DE); Stefan SITZMANN (deceased), Forchheim (DE); Werner SCHMIDT, Forchheim (DE); Stefan KRÜGEL, Ebermannstadt (DE); Matthias SEELER, Eggolsheim (DE); Gerald DITTRICH, Forchheim (DE)

(21) Appl. No.: 16/961,874

(22) PCT Filed: Jan. 18, 2019
(86) PCT No.: PCT/EP2019/051196

§ 371 Date: Jul. 13, 2020

(30) Foreign Application Priority Data
Jan. 22, 2018 (DE) 10 2018 101 331.0

(51) Int. Cl. C09J 7/40; B32B 7/06; B32B 27/08; B32B 27/32; B32B 27/28

(52) U.S. Cl. CPC C09J 7/401; C09J 7/403; C09J 7/405; B32B 7/06; C09J 2483/005; B32B 27/32; B32B 27/283; C09J 2301/416; C09J 2423/005; B32B 27/08

(57) ABSTRACT

The invention relates to a release foil comprising a substrate layer, a printed image and a release coating, wherein the the printed image is arranged at least partially between the substrate layer and the release coating, wherein the printed image includes at least one dye that is cured by UV radiation, and wherein the release coating includes a polysiloxane that is cured by UV radiation.

The invention relates to a release film comprising a carrier layer, a printed image, and a release coating, wherein the printed image is disposed at least partly between the carrier layer and the release coating, wherein the printed image comprises at least one ink cured by UV radiation, and wherein the release coating comprises a polysiloxane cured by UV radiation; to the use of the release film as a means of packaging; and to a method for producing the release film.

Release films are much in use as removable protective films for adhesive tapes, self-adhesive labels, or adherent sanitary and hygiene articles, to prevent these single-sidedly or double-sidedly adhesive products from sticking during storage or processing. This requires that release films be distinguished by an effective release action in respect of adhesives such as, for example, pressure-sensitive adhesives or other adherent materials. To ensure these qualities, release films frequently have a release coating, which may be based, for example, on a polysiloxane.

It is frequently desirable, furthermore, for the release films to be printed, specifically for informative purposes or on aesthetic, production-related or other grounds. For example, colored registration, control and/or print marks, i.e., colored markings, may have been printed in defined intervals on the carrier side adjacent to or below the release coating of the release film. Through optical techniques, during the production or packaging of products, such as sanitary or hygiene products, for example, these colored registration, control and/or print marks then enable the precise placement of the release films and of the products relative to one another in an apparatus intended for the purpose.

WO 1993/23310 relates to a flexible container for packaging products with a pressure-sensitive adhesive thereon, such as sanitary towels, for example. The container is formed from a paper or polymeric film coated on one side with a layer of silicone, the container construction being such that the silicone coating defines the inside faces of the container. By virtue of the antistick quality of the silicone coating, there is no need for the usual protective liner for the adhesive on the packaged product.

WO 1990/007560 discloses a method for providing at least one surface of a substrate (carrier element), particularly a liner, with at least one coating of at least one release agent (agent repelling adhesive substances) in such a way as to form, in the manner of a grid, subareas having different release force values (release forces).

WO 2005/075592 relates to a release layer carrier having a sheetlike substrate and a release layer applied thereon. The release layer carrier is suitable for depositing self-stick adhesive material with a layer of pressure-sensitive adhesive. It features a relief structure with raised ridges which, in the layer of pressure-sensitive adhesive, form substantially complementary channels, which allow entrapped air to escape during bonding.

WO 2007/079921 discloses a method for producing a liner for detachable lining of adhesive areas, especially for the detachable lining of adhesive areas of adhesive tapes or adhesive films, which comprises the following steps: providing a carrier layer; applying one or more raised structures to at least one surface of the carrier layer, the structure or structures being firmly connected to said surface; and covering the surface and the structure or structures connected therewith with a dehesive layer.

US 2004/137242 discloses cationically radiation-curable inks which do not exhibit any ghost images when coated with solvent-free and radiation-curable silicone release coatings. If aggressive adhesives on a solvent basis are poured onto the ink applied to a substrate and are removed after drying, no ghost images are observed. The result is the ability to print graphics onto a substrate and to cover the substrate with a silicone release coating and with a coating having a layer of adhesive, which retains acceptable clarity after the removal of the release coating.

EP 2 576 383 B1 discloses a container having arrangements which indicate manipulation or earlier attempts in the opening of the container. The container includes a removal tab for opening the container in order to gain access to the interior of the container and its contents. The container further includes facilities for the pull tab, which must be separated at least partly from a container substrate in order to gain access to the removal tab. The separating of the pull tab devices provides information on manipulation attempts or prior opening attempts.

DE 19 820 274 discloses a polymeric film having an antistick coating, especially silicone, for producing a packaging wrap having embossed marginal closure strips.

DE 20 2014 105 973 U1 discloses a film having at least one layer comprising at least one homopolymer or copolymer, there being applied over said layer, at least regionally, a heat protection varnish layer, and there being applied over the heat protection varnish layer, at least regionally a coating with at least one polysiloxane.

It is known practice from the prior art to print a carrier film with, for example, a solventborne, e.g. nitrocellulose-based, ink in a first operation, and then to apply a release coating to the dried ink in a second operation.

The production of such release films, however, in view of the separate steps for printing and subsequent application of the release coating, is comparatively costly and inconvenient, and there is a need for improved release films which can be produced by improved methods.

It is an object of the invention to provide improved release films and also a method for producing them.

This object is achieved by the subject matter of the claims.

A first aspect of the invention relates to a release film comprising a carrier layer, a printed image, and a release coating, wherein the printed image is disposed at least partly between the carrier layer and the release coating, so that the printed image is covered over at least part of the area by the release coating, wherein the printed image comprises at least one ink cured by UV radiation, and wherein the release coating comprises a polysiloxane cured by UV radiation.

It has surprisingly been found that in the production of the release film of the invention, one operation (printing step) can be dispensed with and in this way the production time can be considerably shortened, possibly even halved. Printing, curing of the printed image, application of the release coating, and curing of the release coating may be carried out within a few seconds in a joint operation on a single apparatus. On an existing manufacturing line, it is possible in this way to achieve a considerable increase in the production rate, possibly even a doubling.

It has further been surprisingly found that in the production of the release film of the invention, more precise control is possible, since printing and application of the release coating can take place in a concerted manner in a joint operation. Unwanted effects which occur because of the film roll during the conventional second operation for the release coating can be suppressed in this way.

Furthermore, it has surprisingly been found that in the production of the release film of the invention, the attachment of the printed image and of the release coating is improved, especially if solvent-free printing inks are employed. Otherwise, indeed, it may be the case that the release coating develops too little an attachment to an ink layer still containing residual solvent, if that ink layer is based, for example, on nitrocellulose and so requires a solvent.

The film of the invention is a release film, meaning that it is suitable and intended for use as a removable protective film (release liner) for self-adhesive products, such as adhesive tapes, self-adhesive labels or adherent sanitary and hygiene articles, for example. The release film of the invention may also be referred to synonymously as “protective film”.

The release film of the invention is especially suitable for application in packaging of sanitary or hygiene articles, preferably selected from the group encompassing sanitary towels and panty liners (sanitary towel packaging, siliconized single wrapfilm).

The release film of the invention preferably has a total layer thickness of at least 5 μm, more preferably at least 10 μm. The release film of the invention preferably has a total layer thickness in the range from 5 μm to 50 μm, more preferably in the range from 10 μm to 45 μm, more preferably still in the range from 15 μm to 40 μm. Suitable techniques for determining the layer thickness are known to a skilled person. Preferably in accordance with the invention, the layer thickness is ascertained by microtome section.

The film of the invention comprises a carrier layer. A suitable carrier layer in the sense of the invention is fundamentally any layer made of a printable material. The carrier layer is preferably based on a polymer or a mixture of two or more polymers which preferably are thermoplastic, more preferably selected from the group consisting of polyolefins, polyamides, polyesters, and copolymers and/or mixtures of at least two monomers of the stated polymers.

Particularly preferred are polyolefins, mixtures of two or more polyolefins, or mixtures of two or more polyolefins with one or more other polymers. The carrier layer is based more preferably on polyethylene, polypropylene, or a mixture of polyethylene and polypropylene.

To produce the carrier layer it is possible with preference to use thermoplastic polyolefins, thermoplastic olefin homopolymers or copolymers of α,ß-unsaturated olefins having 2 to 10 carbon atoms such as, for example, polyethylenes (PE, especially LDPE or HDPE), polypropylenes (PP), polybutylenes (PB), polyisobutylenes (PI), copolymers and/or mixtures of at least two of the stated polymers.

“LDPE” refers to low-density polyethylene, which has a density in the range of 0.86-0.93 g/cm³ and is distinguished by a high degree of branching of the molecules.

“HDPE” refers to high-density polyethylene, which has only low branching of the molecular chain, and where the density may lie in the range between 0.94 and 0.97 g/cm³. Preferred polyolefins for producing the carrier layer are ethylene homopolymers or copolymers and propylene homopolymers or copolymers.

Where polyamides are used to produce the carrier layer, suitability is possessed by thermoplastic aliphatic, semiaromatic or aromatic polyamide homopolymers or copolymers. Such polyamides are polyamides of diamines such as aliphatic diamines having 2-10 carbon atoms, especially hexamethylenediamine, or aromatic diamines having 6-10 carbon atoms, especially p-phenylenediamine, and dicarboxylic acids such as aliphatic or aromatic dicarboxylic acids having 6-14 carbon atoms, such as adipic acid, terephthalic acid or isoterephthalic acid, for example. The polyamides may additionally have been prepared from lactams having 4-10 carbon atoms such as ε-caprolactam, for example. Particularly suitable polyamides for producing the layer (a) are, for example, PA 6, PA 12, PA 66, PA 6, PA 6T and/or mixtures of at least two of the stated polyamides.

As polyesters for producing the carrier layer it is possible to use thermoplastic, aliphatic, semiaromatic or aromatic polyester homopolymers or copolymers. Such polyesters derive from polyols such as, for example, ethylene glycol or 1,4-butanediol and dicarboxylic acids or dicarboxylic acid derivatives such as adipic acid and/or terephthalic acid. To produce the carrier layer or layers it is also possible in accordance with the invention to use polycarbonates (PCs) as polyesters. Of preferential suitability are polybutylene adipate (PBA), polyethylene terephthalate (PET), polybutylene terephthalate (PBT) or the corresponding copolymers.

The carrier layer may in principle be colored and for that purpose may optionally be equipped with pigments or may be transparent with respect to light. The carrier layer is preferably colored.

The carrier layer of the invention preferably has a layer thickness of at least 5 μm, more preferably at least 10 μm. The carrier layer of the invention preferably has a layer thickness in the range from 5 μm to 50 μm, more preferably in the range from 10 μm to 45 μm, more preferably still in the range from 15 μm to 40 μm. Suitable techniques for determining the layer thickness are known to a skilled person. With preference in accordance with the invention, the layer thickness is ascertained by microtome section.

To improve the printability, it is possible for at least one of the two surfaces of the carrier layer to have been pretreated over all or parts of its area, in particular through use of measures which increase the surface tension, especially plasma and corona methods. The pretreatment in that case takes place preferably at least in those regions of the surface later printed with the printed image. The carrier layer preferably has a surface tension, on the front side facing the printed image, of at least 30 mN/m, more preferably at least 35 mN/m, and more preferably still at least 40 mN/m.

The film of the invention comprises a printed image which comprises at least one ink cured by UV radiation. The printed image preferably comprises a plurality of different inks cured by UV radiation. Suitable inks with which carrier films can be printed, and which can be cured by UV radiation, are known to a skilled person and are available commercially (e.g., UV product group, Siegwerk or FLEXOCURE GEMINI® product group, FlintGroup).

In one preferred embodiment the ink cured by UV radiation is radically cured. In this case the ink cured by UV radiation is based preferably on an acrylate composition which is curable by UV radiation (e.g. FLEXOCURE GEMINI®;YELLOW, FlintGroup, FLEXOCURE GEMINI®;BLACK FlintGroup or UV 259, Siegwerk.

In another preferred embodiment, the ink cured by UV radiation is cationically cured. In this case the ink cured by UV radiation is based preferably on an epoxy composition which is curable by UV radiation (e.g. UV 16, Siegwerk).

A skilled person has analytical techniques available with which even subsequently, on the basis of the completed release film, it is possible to investigate whether curing has taken place by a radical reaction or a cationic reaction. This may be done, for example, by spectroscopic techniques such as NMR or IR spectroscopy.

In one preferred embodiment, the ink cured by UV radiation comprises a fluorescent dye or a luminescent dye.

The invention imposes no particular limitation of the printed area of the printed image. With preference the printed image is printed not over the entire surface of the carrier layer. The printed area of the printed image is preferably in the range from 1% to 99% of the surface of the carrier layer, more preferably in the range from 5% to 95%, more preferably still in the range from 10% to 90%.

The film of the invention comprises a release coating which comprises a polysiloxane cured by UV radiation. Suitable coating compositions with which printed carrier films can be coated, and which can be cured by UV radiation, are likewise known to a skilled person and likewise available commercially (e.g. TEGO® RC, Evonik or SILFORCE® UV, Momentive).

The term “polysiloxane” is understood in the sense of the invention to refer to compounds whose polymer chains are constructed alternately of silicon atoms and oxygen atoms. A polysiloxane is based on n repeating siloxane units (—[Si(R₂)—O]—)ₙ, which are in each case independently of one another disubstituted by two organic radicals R, with R preferably being in each case R¹ or OR¹ and with R¹ being in each case an alkyl radical or an aryl radical.

The cured polysiloxane of the invention is based preferably on a repeating dialkylsiloxane unit or on a repeating alkylaryl siloxane unit. Depending on the number of Si—O bonds in an individual siloxane unit, based in each case on a tetravalent silicon atom, these units can be differentiated into terminal monofunctional siloxanes (M) having one Si—O bond, difunctional siloxanes (D) having two Si—O bonds, trifunctional siloxanes (T) having three Si—O bonds, and tetrafunctional siloxanes (Q) having four Si—O bonds.

The polysiloxane used in the invention preferably has a crosslinked cyclic or catenated structure, more preferably a crosslinked catenated structure, which is linked through (D), (T), and/or (Q) units to form a two- or three-dimensional network.

In one preferred embodiment, the polysiloxane cured by UV radiation is radically cured. In this case the polysiloxane cured by UV radiation is based preferably on an acrylate composition which is curable by UV radiation (e.g., TEGO® RC 702, Evonik).

In another preferred embodiment, the polysiloxane cured by UV radiation is cationically cured. In this case the polysiloxane cured by UV radiation is based preferably on an epoxy composition which is curable by UV radiation (e.g., TEGO® RC 1401, Evonik or SILFORCE® UV9800, Momentive.

The release coating of the release film of the invention is based preferably on at least one cured, i.e., crosslinked polysiloxane selected from the group consisting of polysiloxanes which are addition-crosslinked, preferably addition-crosslinked with metal catalysis, condensation-crosslinked, radically crosslinked, and/or cationically crosslinked. The release coating of the release film of the invention is based preferably on at least one cured polysiloxane selected from the group consisting of polydialkylsiloxanes, preferably polydimethylsiloxanes, and polyalkylarylsiloxanes, preferably polymethylphenylsiloxanes, which in each case are cured.

The surface weight of the release coating of the release film of the invention is preferably ≤5 g/m², more preferably ≤2 g/m², and very preferably is in the range from 0.1 g/m² to 1.5 g/m².

The release film of the invention preferably has a single-sided silicone coating, i.e., only as one of its surface layers. Alternatively the release film of the invention may have a double-sided silicone coating.

The area of the release coating is not subject to particular limitation in the invention. In one preferred embodiment, the release coating does not cover the entire surface of the carrier layer (repeat). In another preferred embodiment, the entire surface of the carrier layer is covered with the release coating. The area of the release coating is preferably in the range from 1% to 100% of the surface of the carrier layer, more preferably in the range from 50% to 100%, more preferably still in the range from 75% to 100%.

The printed image may be an individual coherent structure or may comprise two or more structures separate from one another. It is preferred for such two or more structures separate from one another to be printed in a joint step, with different inks preferably being printed on in temporal succession, by flexographic printing, for example.

In the film of the invention, the printed image is disposed at least partly between the carrier layer and the release coating, and so the printed image is covered over at least part of its area by the release coating. The printed image is preferably disposed completely between the carrier layer and the release coating, so that the release coating covers the printed image over its full area. The area of the release coating is preferably greater than the printed area of the printed image, meaning that unprinted regions of the surface of the carrier layer are also covered by the release coating.

The printed image preferably borders directly on the carrier layer and directly on the release coating, i.e., it contacts both the carrier layer directly and the release coating directly.

In one preferred embodiment, on the reverse side of the carrier layer, facing away from the printed image, the release film of the invention comprises at least one further layer, preferably at least one further layer based on at least one thermoplastic polymer. In a preferred embodiment, on the reverse side of the carrier layer, facing away from the printed image, the release film of the invention comprises two or more further layers, preferably based independently of one another each on at least one thermoplastic polymer.

In one preferred embodiment, a further layer is a barrier layer or a plurality of further layers are barrier layers, preferably an oxygen barrier layer, water vapor barrier layer or oil barrier layer.

Suitability for producing barrier layers is possessed preferably by at least one thermoplastic polymer, more preferably at least one thermoplastic polymer selected from the group encompassing polyamides, ethylene-vinyl alcohol copolymers (EVOH), polyvinyl alcohols (PVOH), and a mixture of at least two of the stated polymers.

The polyamides (PA) used for producing barrier layers are preferably the same polyamides, elucidated in more detail above, which can also be used for producing the carrier layer of the release film of the invention. The polyvinyl alcohols used for producing the barrier layer are obtained by complete or incomplete hydrolysis of corresponding polyvinyl acetates (PVA) and accordingly comprise not only partly saponified polyvinyl acetates, having a degree of saponification of 50 to 98 mol %, but also fully saponified polyvinyl acetates, having a degree of saponification ≥98%. The ethylene-vinyl alcohol copolymers (EVOH) used for producing the barrier layer are obtained by complete or incomplete hydrolysis of corresponding ethylene-containing polyvinyl acetates (EVAc) and encompass, in particular, fully saponified, ethylene-containing polyvinyl acetates having a degree of saponification ≥98%.

The carrier layer of the invention is preferably part of a multilayer film, preferably part of a multilayer blown or cast film or part of a multilayer film assembly, preferably in the form of a tubular film. The carrier layer of the invention is more preferably part of a multilayer blown film.

The carrier layer of the invention is preferably part of a multilayer film which comprises in total at least 2, 3, 4 or 5 layers, of which the carrier layer is one layer. The individual layers of the multilayer film may in that case serve for different purposes in accordance with the invention. For example, the sealability of the multilayer film may be influenced by the composition and layer thickness of the external layer. Also possible is the functionalization and/or dulling of individual layers. Stabilization may be accomplished preferably via the middle layer of the multilayer film.

One or more barrier layers may preferably, in accordance with the invention, prevent migratable constituents of the packaged contents, such as of a pressure-sensitive adhesive on a sanitary towel, for example, from migrating through the multilayer film and in that way reaching, for example, the surround packaging.

In one preferred embodiment, the carrier layer of the invention is part of an at least monoaxially oriented multilayer polymeric film with release effect, which consists at least to an extent of 50 wt % of polyolefins and has a total thickness <18 μm, preferably <12 μm, and has an at least partial embossing on at least one surface. Preferred embodiments of this multilayer polymeric film are described in WO 2015/139844, which is hereby referenced for its entire disclosure content, also in relation to preferred embodiments of the invention.

In another preferred embodiment, the carrier layer of the invention is part of a flexible polymeric film which is at least monoaxially oriented and is optionally embossed and has a machine-direction tear strength which is different by at least 30% from the tear strength crosswise to the machine direction. Preferred embodiments of this multilayer polymeric film are described in WO 2015/139845, which is hereby referenced for its entire disclosure content, also in relation to preferred embodiments of the invention.

In another preferred embodiment, the carrier layer of the invention is part of a multilayer polymeric film which is oriented at least monoaxially in machine direction to at least 1:2, which consists at least to an extent of 50 wt % of polyolefins, and which has a total thickness ≤18 m, preferably ≤12 m, and has an elongation of up to at most 1% under a tensile force of at least 3N per 25 mm width in accordance with DIN EN ISO 527-3. Preferred embodiments of this multilayer polymeric film are described in WO 2015/139843, which is hereby referenced for its entire disclosure content, also in relation to preferred embodiments of the invention.

In a further preferred embodiment, the carrier layer of the invention is part of a multilayer polyolefin film comprising a layer sequence of
a) a sealable layer (a) based on a polyethylene component having a density in the range from 0.910 to 0.940 g/cm³ and a melting point in the range from 110° C. to 130° C.,
b) a layer (b) based on a polymer mixture of 51-85 wt % of at least one polyethylene having a density of 0.910 to 0.940 g/cm³ and 15-49 wt %, based in each case on the total weight of the polymer mixture, of at least one propylene homopolymer or copolymer,
c) a sealable layer (c) based on a polyethylene component having a density in the range from 0.910 to 0.940 g/cm³ and a melting point in the range from 110° C. to 130° C.,
   where the melting point of the layer (a) or of the layer (c) is lower by at least 5° C. than the melting point of the layer (b), where the machine direction [MD] tear strength is <5 N and the tear strength crosswise to the machine direction [CD] is at least four times higher than in [MD], in each case measured according to DIN 53356, and the tensile strength is approximately the same in the machine direction [MD] as crosswise to the machine direction [CD] and is >15 N, measured according to DIN ISO 527-3. Preferred embodiments of this multilayer polymeric film are described in WO 2017/016660, which is hereby referenced for its entire disclosure content, also in relation to preferred embodiments of the invention.

In another preferred embodiment, the release film of the invention comprises no layers other than the carrier layer and the release coating; in other words, in that case, the release film of the invention consists of the carrier layer and the release coating (and also of the printed image and, where present, further printed images). In that case the carrier layer of the invention is preferably a single-layer blown film or cast film.

The release coating, the carrier layer, and any further layer or layers present in the release film of the invention may if necessary, in each case independently of one another, have been furnished or doped with adjuvants, preferably selected from the group consisting of antiblocking agents, antistats, antifog agents, active antimicrobial ingredients, dyes, color pigments, stabilizing agents, preferably heat stabilizers, process stabilizers, process assistants, flame retardants, nucleating agents, crystallization agents, preferably crystal seed formers, lubricants, optical brighteners, flexibilizers, sealing agents, plasticizers, spacers, fillers, peel additives, waxes, wetting agents, surface-active compounds, preferably surfactants, and dispersants. In this case the release effect of the silicone coating, i.e., of the polysiloxane, must be maintained.

The release coating, the carrier layer, and any other layer or layers of the release film of the invention may if necessary, in each case independently of one another, comprise at least 0.01-30 wt %, preferably at least 0.1-20 wt %, based in each case on the total weight of an individual layer, independently of one another, of at least one of the aforesaid adjuvants.

In one preferred embodiment, as well as the printed image on the carrier layer, and specifically on its reverse side facing away from the printed image, the release film of the invention comprises a further printed image.

With preference the printed image and the further printed image are different from one another. It is preferred, for example, for one of the two printed images to comprise operating instructions for the packaged contents, and for the other of the two printed images to represent instructions for disposing of the packaged contents after use thereof in the manner intended.

If the carrier layer is transparent, then the printed image and the further printed image may both be viewed in plan view onto the release coating and the underlying printed image. That is, the further printed image shows through the transparent carrier layer.

In one preferred embodiment of the release film of the invention, the printed image and/or the further printed image are/is a registration, control and/or print mark, which is disposed preferably in the marginal region of the release film.

In one particularly preferred embodiment of the release film of the invention, the printed image and/or the further printed image are/is an additional registration, control and/or print mark, which is preferably disposed in the marginal region of the release film.

With preference in the invention, the “marginal region of the release film” embraces the 20%, more preferably 10%, facing the edge, of the total extent of the release film orthogonally to the edge at the respective point. Where, for example, the release film has a total extent (width) of 15 cm orthogonally to the edge, the marginal region of the release film at this point preferably embraces the 3 cm, more preferably 1.5 cm, facing the edge.

In one particularly preferred embodiment of the release film of the invention, the film, over at least part of the area on its two outer sides, has a release coating, the composition of the release coating being preferably in each case identical. If the carrier layer is the only layer, then preferably both outer sides of the carrier layer have a release coating over at least part of their area. If the carrier layer is part of a multilayer film, then the carrier layer has a release coating over at least part of the area on the side facing the printed image, and the opposite outermost layer of the multilayer film, i.e., the other outer side, likewise has a further release coating over at least part of the area.

A further aspect of the invention relates to a packaging for a sanitary or hygiene article, preferably selected from the group encompassing sanitary towels and panty liners, wherein the packaging comprises the above-described release film of the invention.

The packaging of the invention is preferably in the form of a packaging wrap. The overall packaging preferably consists of the release film and the packaged contents (hygiene article).

The carrier layer has a printed image, which is preferably concealed entirely or at least partly by the hygiene article in front of it. On the reverse side of the hygiene article there is preferably a pressure-sensitive adhesive, via which the hygiene article is attached on the release coating. The pressure-sensitive adhesive can be detached from the release coating by manual pulling, and the hygiene article can be withdrawn from the packaging. The force of attachment of the pressure-sensitive adhesive on the hygiene article here is preferably greater than the force of attachment on the release coating, and so the pressure-sensitive adhesive remains on the hygiene article on withdrawal from the packaging. The pressure-sensitive adhesive may preferably then fulfil further functions. For example, if the hygiene article is a sanitary towel, it may, in the course of its use as intended, be attached via the pressure-sensitive adhesive, on the inside of the underwear. As a result of the withdrawal of the hygiene article, the printed image lying behind is completely visible and may serve, for instance, for aesthetic purposes and/or may comprise—in the form of pictograms and/or text, for example—instructions for the disposal of the hygiene article after its use in the manner intended.

In one preferred embodiment, the carrier layer in the marginal region in each case has a strip of pressure-sensitive adhesive, via which the packaging can be closed at the sides during wrapping. The packaging is preferably reclosable. A skilled person recognizes that for closing at the sides there are, alternatively, other possibilities which can also be used, such as heat-sealing, crimping, etc., for example. In order to ensure reclosability, it is preferred in the invention to use a pressure-sensitive adhesive.

In one preferred embodiment, the arrangement of the hygiene article relative to the carrier layer is not centered, but instead a lateral offset, and so a region of the hygiene article overhangs at the margin of the carrier layer.

For the purpose of explaining the functioning of the packaging wrap, the operation of reclosing is described below. On first-time opening of the packaging wrap, the corresponding steps are traversed in the opposite order. To explain the functioning of the packaging as a packaging wrap, the release film can be subdivided notionally via a first wrapping fold into a narrow wrap section and also a middle wrap section. Furthermore, the release film may be subdivided via a second wrapping fold into the middle wrap section and also a wide wrap section.

On reclosing, in a first step, the narrow wrap section is wrapped (folded in) along the first wrapping fold, and consequently a further printed image disposed, optionally, on the reverse side becomes disposed on the front side of the packaging and therefore becomes visible in a plan view. The further printed image may serve aesthetic purposes and/or—in the form of pictograms and/or text, for example—may comprise instructions for the withdrawal of the sanitary towel in the intended manner from the packaging. By way of the preferred pressure-sensitive adhesive applied in the marginal region, the middle wrap section on the reverse side and also the narrow wrap section on the front side then form a kind of closed pouch, with the wrapped sanitary towel reaching into the opening of said pouch.

During reclosing, in a second step, the middle wrap section and also the narrow wrap section folded over it are again wrapped (folded in) along the second wrapping fold, and consequently another section of the further printed image, disposed optionally on the reverse side, becomes disposed on the front side of the package and therefore becomes visible in a plan view. The further printed image may likewise serve aesthetic purposes and/or—in the form of pictograms and/or text, for example—may comprise instructions for the withdrawal of the sanitary towel from the packaging in the manner intended. By way of the preferred pressure-sensitive adhesive applied in the marginal region, the wide wrap section on the reverse side and also the middle wrap section on the front side, and also the centrally disposed narrow wrap section, form a kind of closed pouch, in the interior of which the doubly wrapped hygiene article is located.

An overhanging region of the release film in this case is preferably not concealed by the broad wrap section, and therefore remains visible and may serve, for example, as a tab for the easier opening of the packaging using the hands. A skilled person recognizes that it may be advantageous if the reverse side of the carrier layer as well, or, in the case of a multilayer film, the reverse-side outer layer of the release film, has a further release coating at least in the marginal region, so that the pressure-sensitive adhesive attaches thereon and is also detachable therefrom again.

A further aspect of the invention relates to the use of the above-described release film of the invention as packaging material for a sanitary or hygiene article, preferably selected from the group encompassing sanitary towels and panty liners.

A further aspect of the invention relates to a method for producing the above-described release film of the invention, wherein the method comprises the steps of
(a) printing at least part of the surface of a carrier layer with at least one ink curable by UV radiation;
(b) irradiating the curable ink with UV radiation;
(c) applying a coating composition which comprises a polysiloxane curable by UV radiation to at least part of the printed surface of the carrier layer; and
(d) irradiating the curable polysiloxane with UV radiation.

The release film of the invention may be produced by known production methods such as, for example, lamination or (co)extrusion, preferably by coextrusion. In that case the carrier layer and/or the optionally present further layer or optionally present further layers may be formed by extrusion, preferably by flat film extrusion (cast extrusion) or blown film extrusion, more particularly by flat film coextrusion (cast coextrusion) or blown film coextrusion, the invention giving preference to blown film coextrusion.

Preferably the carrier layer and/or the optionally present further layer or optionally present further layers may optionally be produced and processed as a multilayer film, optionally in the form of a tubular film.

The resulting single-layer or preferably multilayer blown film or cast film, or the resulting overall—optionally multilayer—film assembly in the form of a tubular film, may be embossed directly thereafter without prior storage or alternatively as part of its actual production. Preferably the single-layer or preferably multilayer blown film or cast film or the—optionally multilayer—film assembly is embossed in the form of a tubular film during its actual production.

Steps (a) to (d) preferably take place temporally in alphabetical order, with it being possible for steps (a) and (b), steps (b) and (c), and/or steps (c) and (d) independently of one another to be carried out at least partly simultaneously. In particular it is preferred in the invention that the curing of the curable ink, which is induced by UV radiation in step (b), need not have been entirely concluded if the coating composition is applied already in step (c) and is subsequently irradiated with UV radiation in step (d).

Preferably step (d) is carried out no later than 300 seconds after step (b), and so steps (a) to (d) are carried out virtually in a joint operation. In preferred embodiments, step (d) is carried out not later than 240 seconds, or not later than 180 seconds, or not later than 120 seconds, or not later than 60 seconds, or not later than 30 seconds, or not later than 10 seconds after step (b). In preferred embodiments, step (d) is carried out not later than 9 seconds, or not later than 8 seconds, or not later than 7 seconds, or not later than 6 seconds, or not later than 5 seconds, or not later than 4 seconds after step (b). Since the method of the invention is preferably carried out continuously, a skilled person recognizes that the above time details in this case refer to specific portions of the release film of the invention, if these portions, for example, are first printed with the printed image and irradiated on a common central cylinder with a plurality of inking units in series, and immediately thereafter are coated with the release coating and irradiated again. The interval of time between steps (b) and (d) in that case is a product of the physical distance between the UV radiation sources on the periphery of the common central cylinder and the machine speed. The downstream printing unit for the application of the coating composition may alternatively also be secured on an independent central impression cylinder.

The machine speed is preferably in the range of 100 and 800 m/min, preferably 200 m/min and 450 m/min, and is dependent on the type of the carrier film, on the number of different printing technologies and printing inks, or else on a possibly required precise control of a plurality of printing and/or coating operations.

With preference both the ink for the printed image and the release coating, e.g., a coating composition for producing UV-curable silicone layers, are printed in direct succession in a single, joint operation, e.g., on a common central cylinder, in a first inking unit (printed image) and a second inking unit (release coating). In that case the release coating may be applied over the full area or a part of the area (repeat).

In one preferred embodiment, the release coating is applied over part of the area (repeat) in a controlled way, it being possible for the control to take place by means of a registration, control and/or print mark or the printed image beneath the release coating.

In one preferred embodiment, a further printed image is applied on the reverse side of the carrier film, facing away from the printed image, and the printing of this further printed image takes place preferably without control. In one preferred embodiment the release coating is applied over a part of the area (repeat) in a controlled way, in which case the control may take place with the aid of this further printed image on the reverse side of the carrier film, facing away from the printed image.

Registration, control and/or print marks are known to a skilled person and may fulfil various functions. With preference in accordance with the invention, the registration, control and/or print mark may serve
during the printing in step (a), to specify the relative position of the printed image on the release film;
if additionally present, during printing, to specify the relative position of the further printed image on the release film;
during application of the release coating in step (c), to specify the relative position of the release coating on the release film, especially if the release coating is applied only over part of the area; and/or
during the subsequent use of the release film, as packaging material, for example, to specify the relative position of the packaged contents and/or of a pressure sensitive adhesive applied on the packaged contents on the release film and/or on the release coating.

The UV radiation used in step (b) preferably has substantially the same wavelength as the UV radiation used in step (d).

In this context, printing inks and/or coating compositions which are cationically curable (e.g., epoxy-based) sometimes have the advantage that the curing is not adversely affected by the oxygen present in the air, and so there is no need for inert gas to be used. On the other hand, however, such printing inks and/or coating compositions sometimes have a tendency to cause odor-nuisance.

In contrast to this, printing inks and/or coating compositions which are radically curable (acrylate-based for example) sometimes have the advantage that they do not cause any odor-nuisance. On the other hand, however, such printing inks and/or coating compositions necessitate the use of inert gases.

In preferred embodiments of the method of the invention
(i) the ink curable by UV radiation is radically curable and the polysiloxane curable by UV radiation is radically curable;
(ii) the ink curable by UV radiation is radically curable and the polysiloxane curable by UV radiation is cationically curable;
(iii) the ink curable by UV radiation is cationically curable and the polysiloxane curable by UV radiation is radically curable; or
(iv) the ink curable by UV radiation is cationically curable and the polysiloxane curable by UV radiation is cationically curable.

In one preferred embodiment of the method of the invention, steps (a) to (d) are carried out under protective gas atmosphere.

In another preferred embodiment of the method of the invention, steps (a) to (d) are carried out without protective gas atmosphere.

In preferred embodiments of the method of the invention
(i) the ink curable by UV radiation comprises a solvent and the polysiloxane curable by UV radiation comprises a solvent;
(ii) the ink curable by UV radiation comprises a solvent and the polysiloxane curable by UV radiation is solvent-free;
(iii) the ink curable by UV radiation is solvent-free and the polysiloxane curable by UV radiation comprises a solvent; or
(iv) the ink curable by UV radiation is solvent-free and the polysiloxane curable by UV radiation is solvent-free.

FIG. 1 illustrates schematically a preferred embodiment of the release film of the invention, comprising carrier layer (1), printed image (2), and release coating (3). In the embodiment of FIG. 1 the release coating (3) is applied over the full area to the carrier layer (1), including the printed image (2), and so the area of the release coating (3) corresponds to the area of the carrier layer (1).

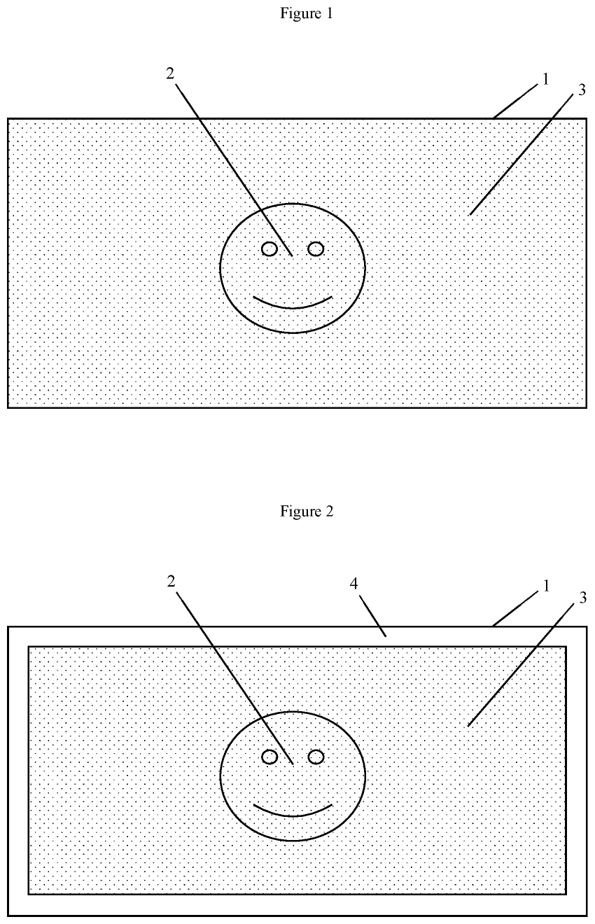

FIG. 2 illustrates schematically a preferred variant of the release film of the invention, comprising carrier layer (1), printed image (2), and release coating (3). In the embodiment of FIG. 2 the release coating (3) is applied over part of the area to the carrier layer (1), including the printed image (2), and so the area of the release coating (3) is smaller than the area of the carrier layer (1); a marginal region (4) remains, which is not covered with the release coating (3).

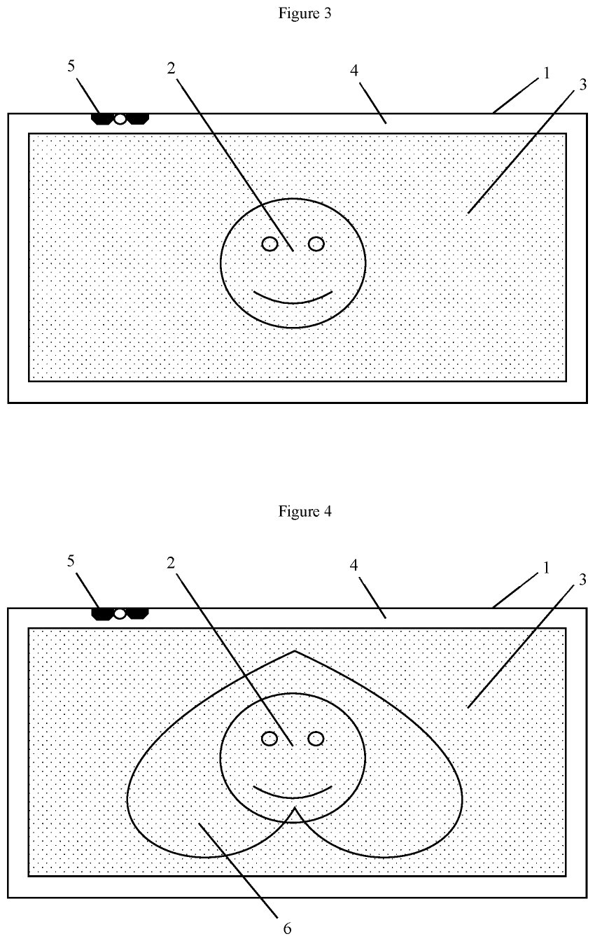

FIG. 3 illustrates schematically a preferred variant of the release film of the invention, comprising carrier layer (1), printed image (2), and release coating (3), which as well as the printed image (2) in the marginal region (4) has a registration, control and/or print mark (5).

FIG. 4 illustrates schematically a preferred variant of the release film of the invention, comprising carrier layer (1), printed image (2), release coating (3), marginal region (4), registration, control and/or print mark (5), with a further printed image (6) on the reverse side.

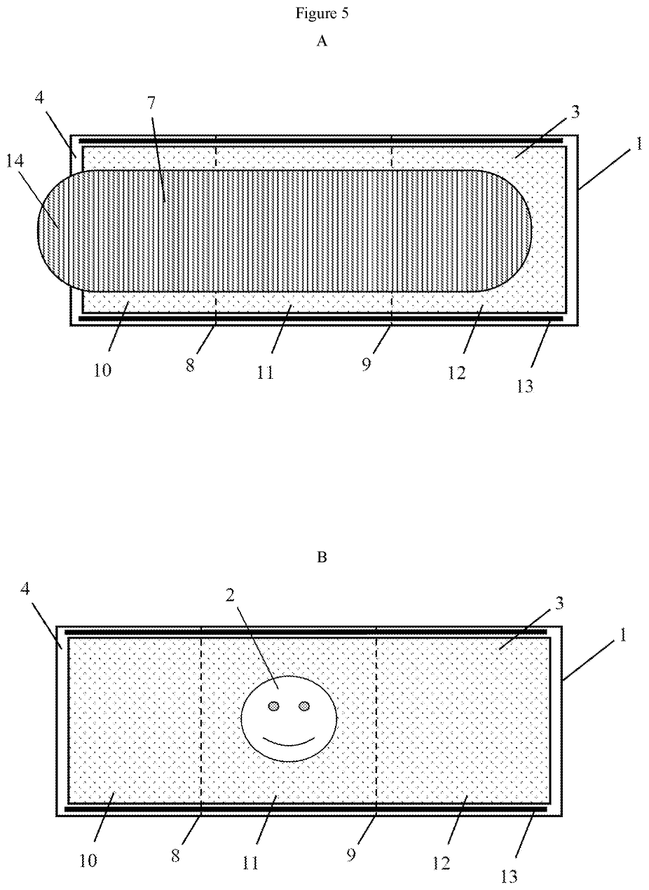

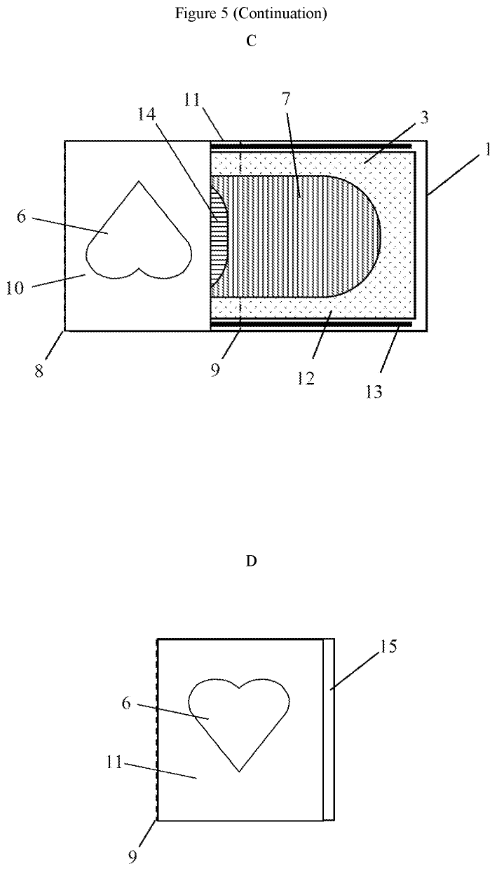

FIG. 5 illustrates schematically packaging preferred in the invention for a hygiene article and comprising the release film of the invention. This packaging takes the exemplary form of a packaging wrap for a sanitary towel, but may also be used for packaging other packaged contents, especially hygiene articles. The entire packaging preferably consists of the release film and the sanitary towel. The release film of the packaging of the invention may comprise registration, control and/or print marks, though in FIG. 5 these have been omitted for reasons of clarity. FIGS. 5A to 5D show different states of the packaging of the invention.

FIG. 5A shows the packaging of the invention in the fully unfolded state. The carrier layer (1) has a printed image, which in the state shown is concealed by the sanitary towel (7) in front of it. A skilled person recognizes that the printed image may alternatively also be disposed at an offset to the sanitary towel (7) and/or may be given such an extensive design that at least parts of it are not concealed by the sanitary towel (7), i.e., are visible. The release coating (3) is applied over part of the area to the carrier layer (1), including the printed image, and so the area of the release coating (3) is smaller than the area of the carrier layer (1); a marginal region (4) remains which is not covered with the release coating (3). Preferably on its reverse side the sanitary towel (7) has a pressure-sensitive adhesive (not shown) via which it is attached on the release coating (3). By manual removal it is possible to detach the sanitary towel together with the pressure-sensitive adhesive on the release coating (3). Subsequently, in the course of the as-intended use of the sanitary towel (7), the pressure-sensitive adhesive may serve for attaching on the inside of the underwear. On the two long sides, in the marginal region (4), the carrier layer (1) has a respective strip of pressure-sensitive adhesive (13), by which the packaging can be closed at the sides by wrapping. Preferably the packaging is reclosable. A skilled person recognizes that other possibilities can also be used, alternatively, for the closing at the sides—such as, for example, heat sealing, crimping, etc. Preferably the sanitary towel (7) is not arranged so as to be centered relative to the carrier layer, but instead has a lateral offset, so that a region (14) protrudes beyond the sanitary towel on the margin of the carrier layer (1). The release film may be given an imaginary subdivision, via a first wrapping fold (8), into a narrow wrap section (10) and also a middle wrap section (11). Furthermore, the release film can be subdivided by a second wrapping fold (9) into the middle wrap section (11) and also a wide wrap section (12).

FIG. 5B shows the packaging of the invention in the fully unfolded state after the removal of the sanitary towel. The printed image (2) behind it is visible in this way and may serve aesthetic purposes and/or, in the form of pictograms and/or text, for example, may comprise instructions for the disposal of the sanitary towel after it has been used in the intended way.

FIG. 5C shows the packaging of the invention in the partly unfolded state. This state may occur both during the first-time opening of the packaging and also when it is reclosed. The narrow wrap section (10) in this case is wrapped (folded in) along the first wrapping fold (8), and so the further printed image (6), which in FIGS. 5A/B is disposed on the reverse side and is therefore still not visible there in the plan view shown, is disposed, according to FIG. 5C, on the front side of the packaging and therefore becomes visible in the plan view shown. The further printed image may serve aesthetic purposes and/or, in the form of pictograms and/or text, for example, may comprise instructions for the proper removal of the sanitary towel from the packaging. By way of the pressure-sensitive adhesive (13) applied in the marginal region (4), the middle wrap section (11) on the reverse side and also the narrow wrap section (10) on the front side form a kind of closed pouch, with the wrapped sanitary towel (7) reaching into the opening of said pouch. The protruding region (14) of the sanitary towel (7) is in this case not concealed by the narrow wrap section (10), and thus remains visible (on the reverse side in comparison to the representation as per FIG. 5A).

FIG. 5D shows the packaging of the invention in the fully closed state. This state may likewise occur both during the first-time opening of the packaging and when it is reclosed. The middle wrap section (11) and also the narrow wrap section (10) folded over it are in this case again wrapped (folded in) along the second wrapping fold (9), and so a different section of the further printed image (6), which in FIGS. 5A/B was disposed on the reverse side and is therefore still not visible there in the plan view shown, is disposed, according to FIG. 5D, on the front side of the packaging and therefore becomes visible in the plan view shown. The further printed image may likewise serve aesthetic purposes and/or, in the form of pictograms and/or text, for example, may comprise instructions for the proper removal of the sanitary towel from the packaging. The further printed image (6) shown in FIG. 5C is concealed in this way. Via the pressure-sensitive adhesive (13) applied in the marginal region (4), the reverse-side wide wrap section (12) and also the front-side middle wrap section (11) and also the centrally disposed narrow wrap section (10) form a kind of closed pouch, with the doubly wrapped sanitary towel (7) located in the interior of said pouch. Preferably in this case a protruding region (15) of the release film is not concealed by the wide wrap section (12), and thus remains visible and may serve, for example, as a tab for making it easier to open the packaging with the hands. A skilled person recognizes that it may be advantageous if the reverse side of the carrier layer (1), or, in the case of a multilayer film, the reverse-side outer layer of the release film shown in FIGS. 5A/B, also has, at least in the marginal region, a further release coating, so that the pressure-sensitive adhesive (13) attaches thereto and can also be detached therefrom again.

### LIST OF REFERENCE SYMBOLS

1—Carrier layer
2—Printed image
3—Release coating
4—Marginal region
5—Registration, control and/or print mark
6—Further printed image
7—Sanitary towel
8—First wrapping fold
9—Second wrapping fold
10—Narrow wrap section
11—Middle wrap section
12—Wide wrap section
13—Pressure-sensitive adhesive
14—Protruding region of the sanitary towel
15—Protruding region of the release film

The examples below serve to illustrate the invention, but should not be interpreted as imposing any limitation.

The carrier layer used was a polyolefin film in 24 m thickness—corona-pretreated (42 mN/n) on one side. The machine speed was 250 m/min in each case.

A conventional flexographic printing process was used, with the printing unit disposed on a central impression cylinder. The printing unit consisted of a press cylinder, which carried the printing sleeve with the print design. The ink was applied to the press cylinder with the print design by means of an engraved roll, and excess ink was stripped from the surface of the engraved roll by a doctor knife (so-called “closed box knife printing unit”).

Siliconization took place in a printing unit downstream of the ink printing unit (and consisting of press cylinder, engraved roll, and box knife), and was used to apply a silicone coating by printing (=“silicone printing unit”). In the experiments, both the ink printing unit and the silicone printing unit were secured on central impression cylinder.

The respective construction of the release films tested is summarized in the table below, with examples C-1 to C-8 being comparative examples and examples I-1 to I-5 being inventive:

| | Printed image | | | Release coating | | |
|---|---|---|---|---|---|---|
| | Chemical | | | Chemical | | |
| | basis of | | Curing | basis of | | Curing |
| Ex. | binder | Solvent | mechanism | siliconization | Solvent | mechanism |
| C-1 | Nitrocell. | EtOAc | thermal | Acrylate | — | UV radic. |
| C-2 | Acrylate | — | UV radic. | Acrylate | — | UV radic. |
| C-3 | Epoxy | — | UV cation. | Acrylate | — | UV radic. |
| C-4 | Acrylate | — | UV radic. | Epoxy | — | UV cation. |
| C-5 | Epoxy | — | UV cation. | Epoxy | — | UV cation. |
| C-6 | Nitrocell. | EtOAc | thermal | Acrylate | EtOAc | UV radic. |
| C-7 | Nitrocell. | EtOAc | thermal | Acrylate | — | UV radic. |
| C-8 | Nitrocell. | EtOAc | thermal | Epoxy | — | UV cation. |
| I-1 | Acrylate | — | UV radic. | Acrylate | — | UV radic. |
| I-2 | Acrylate | — | UV radic. | Acrylate | EtOAc | UV radic. |
| I-3 | Epoxy | — | UV cation. | Acrylate | — | UV radic. |
| I-4 | Epoxy | — | UV cation. | Epoxy | — | UV cation. |
| I-5 | Epoxy | — | UV cation. | Epoxy | EtOAc | UV cation. |

EtOAc: Ethyl acetate
Nitrocell.: Nitrocellulose
UV radic.: radical curing reaction induced by UV radiation
UV cation.: cationic curing reaction induced by UV radiation

The respective number of operations and also the times required in each case for production are summarized in the table below:

| | | Machine time | Set-up | | Time between | |
|---|---|---|---|---|---|---|
| | Number of | for 10 000 | for 10.000 | | printing and | |
| Ex. | operations | lin. m. | lin. m. | | coating | |
| C-1 | 2 | 80 min | 100 | min | 2 | hours |
| C-2 | 2 | 80 min | 100 | min | 2 | hours |
| C-3 | 2 | 80 min | 100 | min | 2 | hours |
| C-4 | 2 | 80 min | 100 | min | 2 | hours |
| C-5 | 2 | 80 min | 100 | min | 2 | hours |
| C-6 | 1 | 40 min | 60 | min | <10 | seconds |
| C-7 | 1 | 40 min | 60 | min | <10 | seconds |
| C-8 | 1 | 40 min | 60 | min | <10 | seconds |
| I-1 | 1 | 40 min | 60 | min | <10 | seconds |
| I-2 | 1 | 40 min | 60 | min | <10 | seconds |
| I-3 | 1 | 40 min | 60 | min | <10 | seconds |
| I-4 | 1 | 40 min | 60 | min | <10 | seconds |
| I-5 | 1 | 40 min | 60 | min | <10 | seconds |

Machine time: Pure machine time [min] = Linear meters (reel) [m]/machine speed [m/min]
Set-up time: Pure set-up time includes the insertion and removal of the film reel, the preparation of the inks, the adjustment work, cleaning work, etc.

The release force was determined at 70° C. using an electronic tearing device (resolution 0.02 N). This was done using Tesaband A 7475, 25 mm wide. The freshly siliconized specimens were provided in slabs of around six plies, around 24-29 cm long, and wrapped in black film. These specimens are then conditioned. Conditioning took place in a drying cabinet 2 h/70° C., by wrapping the slabs around the racks. This allowed the air to circulate freely through the racks and thereby heat the slabs uniformly. The samples were removed and the adhesive tape was adhered without bubbles over the areas to be tested. The adhesive tape was rolled down 4× using a Finat roller at a speed of 20 cm/s. The release film was trimmed so that a free margin of 1 cm remained in each case to the side of the adhesive tape. The samples were cut into strips of equal length (around 30 cm long) and labelled. Subsequently the samples were placed between thin metal plates and were weighed down with weights. The loading was uniform. The number of weights was dependent on the number of samples per tier:

| No. of | Number of |
|---|---|
| samples/Tier | weights/each 2.6 kg |
| 12 | 24 |
| 11 | 22 |
| 10 | 20 |
| 9 | 18 |
| 8 | 16 |
| 7 | 14 |
| 6 | 12 |
| 5 | 10 |
| 4 | 8 |
| 3 | 6 |

This corresponded to a loading of 70 g/cm². The samples were subsequently stored for 20 h at 70° C. in the drying cabinet and, after removal, were adhered to a metal support sheet. A stiff film strip was affixed to the test adhesive tape, and the metal support sheet was fastened in the lower clamping jaw, the stiff film strip in the upper clamping jaw, of the Zwick test instrument. After adjustment of the load cell, the test adhesive tape was peeled off at an angle of 1750 and a speed of 300 mm/min.

To determine the “rub off”, the siliconized film was placed flatly onto a smooth underlay. Then the silicone layer was “rubbed” 4-5 times using the thumb. In the case of partial detachment of the silicone film, a “rub off” was recorded. The test was otherwise recorded as “sat.”.

Release values, degrees of cure, anchorage, and “rub off” are summarized in the table below:

| | Release values | | | | |
|---|---|---|---|---|---|
| | 70° C. in the | Degree of cure | | | Rub off |
| | range from 2 | Printed | Release | | silicone |
| Ex. | to 25 cN/10 cm | image | coating | Anchorage | layer |
| C-1 | + | 0 | + | + | sat. |
| C-2 | + | + | + | + | sat. |
| C-3 | + | + | + | + | sat. |
| C-4 | + | + | + | + | sat. |
| C-5 | + | + | + | + | sat. |
| C-6 | + | − | + | − | Rub off |
| C-7 | + | − | + | − | Rub off |
| C-8 | + | − | + | − | Rub off |
| I-1 | + | + | + | + | sat. |
| I-2 | + | + | + | + | sat. |
| I-3 | + | + | + | + | sat. |
| I-4 | + | + | + | + | sat. |
| I-5 | + | + | + | + | sat. |

sat.: satisfactory

As demonstrated by the experimental data above, the production of the release films in accordance with comparative examples C-1 to C-4 involves a high working effort and is consequently associated with a long working time. The release films according to comparative examples C-6 to C-8 do not show these disadvantages, but do exhibit color transfer into the silicone printing unit (contamination) and also rub off.

Conversely, the release films according to inventive examples I-1 and I-2 show no disadvantages at all. In the case of the release films of inventive examples I-3 to I-5, however, it should be borne in mind that an odor nuisance may arise from the use of cationically curing inks and/or coating compositions.

What is claimed is:

1. A release film comprising a carrier layer, a printed image and a release coating, wherein
(a) the printed image is disposed at least partly between the carrier layer and the release coating; and
(b) the printed image comprises at least one ink cured by UV radiation; and
(c) the release coating comprises a polysiloxane cured by UV radiation and has a surface weight of <5 g/m².

2. The release film as claimed in claim 1, wherein the printed image borders both directly onto the carrier layer and directly onto the release coating.

3. The release film as claimed in claim 1, wherein the printed image is disposed completely between the carrier layer and the release coating.

4. The release film as claimed in claim 1, wherein the carrier layer comprises a polyolefin.

5. The release film as claimed in claim 4, wherein the carrier layer comprises a polyolefin which is selected from the group consisting of
thermoplastic olefins; and/or
thermoplastic olefin homopolymers or copolymers of α,ß-unsaturated olefins having 2 to 10 carbon atoms; preferably selected from the group consisting of polyethylene, polypropylene, polybutylene, polyisobutylene (PI), copolymers and/or mixtures of at least two of the stated polymers.

6. The release film as claimed in claim 1, wherein the carrier layer is colored.

7. The release film as claimed in claim 1, wherein the carrier layer has a layer thickness in the range from 5 μm to 50 μm.

8. (canceled)

9. (canceled)

10. (canceled)

11. (canceled)

12. (canceled)

13. The release film as claimed in claim 1, wherein the release coating is based on at least one cured polysiloxane which is selected from the group consisting of polysiloxanes which are addition-crosslinked, condensation-crosslinked, radically crosslinked, and cationically crosslinked.

14. The release film as claimed in claim 1, wherein the release coating is based on at least one cured polysiloxane which is selected from the group consisting of polydialkylsiloxanes, and polyalkylarylsiloxanes.

15. (canceled)

16. The release film as claimed in claim 1, having (a) surface layer(s) as a silicone coating on one side or both sides.

17. The release film as claimed in claim 1, wherein the ink cured by UV radiation comprises a fluorescent dye or a luminescent dye.

18. The release film as claimed in claim 1, which, on the reverse side of the carrier layer, facing away from the printed image, comprises at least one further layer and/or a further printed image.

19. The release film as claimed in claim 1, wherein the release coating, the carrier layer, and also the optionally present further layer or further layers of the release film, each independently of one another, may have been furnished with adjuvants
which are selected from the group consisting of antiblocking agents, antistats, antifog agents, active antimicrobial ingredients, dyes, color pigments, stabilizing agents, process stabilizers, process assistants, flame retardants, nucleating agents, crystallization agents, lubricants, optical brighteners, flexibilizers, sealing agents, plasticizers, spacers, fillers, peel additives, waxes, wetting agents, surface-active compounds, and dispersants; and/or
wherein the weight fraction of the further adjuvants in each case independently of one another is at least 0.01 to 30 wt %, preferably 0.1 to 20 wt %, based in each case on the total weight of the individual layer.

20. The release film as claimed in claim 1, wherein the silicone layer in the context of the FINAT bond strength testing in accordance with the test standard FTM 10, on removal of the test adhesive tape at a temperature of 70° C., a detachment angle of 175°, and a detachment rate of 300 mm/min, corresponding to release values in the range of 2 to 25 cN/10 cm, exhibits no detachment phenomena identified as “rub off”.

21. (canceled)

22. The release film as claimed in claim 1, wherein the printed image and/or a further printed image is or comprises a registration, control and/or print mark.

23. The release film as claimed in claim 22, wherein the registration, control and/or print mark is disposed in a marginal region of the release film.

24. The release film as claimed in claim 1, wherein the ink cured by UV radiation and/or the polysiloxane cured by UV radiation are/is radically or cationically cured.

25. A packaging for a hygiene article, comprising a release film as claimed in claim 1.

26. (canceled)

27. A method for producing a release film as claimed in claim 1, comprising the steps of
(a) printing at least part of the surface of a carrier layer with at least one ink curable by UV radiation;
(b) irradiating the curable ink with UV radiation;
(c) applying a coating composition which comprises a polysiloxane curable by UV radiation to at least part of the printed surface of the carrier layer; and
(d) irradiating the curable polysiloxane with UV radiation;
wherein step (d) is carried out not later than 300 seconds after step (b).

28. (canceled)

29. (canceled)

30. The method as claimed in claim 27, wherein the method is further characterized by one or any combination of the following:
(i) both the ink for the printed image and the release coating are printed in direct succession in a single, joint operation;
(ii) the machine speed is in a range from 100 to 800 m/min;
(iii) the machine speed is in a range from 200 to 450 m/min;
(iv) the UV radiation used in step (b) has substantially the same wavelength as the UV radiation used in step (d):
(v) the ink curable by UV radiation is radically curable and the polysiloxane curable by UV radiation is radically curable;
(vi) the ink curable by UV radiation is radically curable and the polysiloxane curable by UV radiation is cationically curable;
(vii) the ink curable by UV radiation is cationically curable and the polysiloxane curable by UV radiation is radically curable;
(viii) the ink curable by UV radiation is cationically curable and the polysiloxane curable by UV radiation is cationically curable;
(ix) the ink curable by UV radiation comprises a solvent and the polysiloxane curable by UV radiation comprises a solvent;
(x) the ink curable by UV radiation comprises a solvent and the polysiloxane curable by UV radiation is solvent-free;
(xi) the ink curable by UV radiation is solvent-free and the polysiloxane curable by UV radiation comprises a solvent;
(xii) the ink curable by UV radiation is solvent-free and the polysiloxane curable by UV radiation is solvent-free;
(xiii) steps (a) to (d) are carried out under protective gas atmosphere; or
(xiv) steps (a) to (d) are carried out without protective gas atmosphere.

31. (canceled)

32. (canceled)

33. (canceled)

34. (canceled)

35. (canceled)
